(19) United States
(12) Patent Application Publication
(10) Pub. No.: US 2025/0071752 A1
(43) Pub. Date: Feb. 27, 2025

(54) METHOD, DEVICE AND COMPUTER READABLE MEDIUM FOR COMMUNICATIONS

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/719,110

(22) PCT Filed: Dec. 15, 2021
(86) PCT No.: PCT/CN2021/138271

§ 371 Date: Jun. 13, 2024

(51) Int. Cl. H04W 72/1268; H04W 64/00; H04W 76/19; H04W 76/27

(52) U.S. Cl. CPC H04W 72/1268; H04W 64/00; H04W 76/19; H04W 76/27

(57) ABSTRACT

Embodiments of the present disclosure relate to methods, devices and computer readable media for communications. A method implemented at a terminal device comprises receiving, at the terminal device from a network device, first information about a first Artificial Intelligence (AI) model. The method also comprises applying, based on the first information, the first AI model to a first use case associated with the first AI model. The first use case comprises at least one of the following: mobility management for the terminal device, uplink resource allocation for the terminal device, channel state information (CSI) feedback enhancement, beam management, positioning accuracy enhancement, or reference signal (RS) overhead reduction.

### TECHNICAL FIELD

Embodiments of the present disclosure generally relate to the field of telecommunication, and in particular, to methods, devices and computer readable media for communications.

### BACKGROUND

The Fifth Generation (5G) networks are expected to meet the challenges of consistent optimization of increasing numbers of key performance indicators (KPIs) including latency, reliability, connection density, user experience, energy efficiency, and so on. Artificial Intelligence (AI) or Machine learning (ML) provides a powerful tool to help operators to improve the network management and the user experience by analyzing the data collected and autonomously processed that can yield further insights.

The 3rd Generation Partnership Project (3GPP) is now working on air-interface with features enabling improved support of AI/ML based algorithms for enhanced performance and/or reduced complexity or overhead. Enhanced performance may depend on use cases under consideration and could be improved throughput, robustness, accuracy or reliability, or reduced overhead, and so on.

### SUMMARY

In general, example embodiments of the present disclosure provide methods, devices and computer readable media for communications.

In a first aspect, there is provided a method for communications implemented at a terminal device. The method comprises receiving, at the terminal device from a network device, first information about a first Artificial Intelligence (AI) model. The method also comprises applying, based on the first information, the first AI model to a first use case associated with the first AI model. The first use case comprises at least one of the following: mobility management for the terminal device, uplink resource allocation for the terminal device, channel state information (CSI) feedback enhancement, beam management, positioning accuracy enhancement, or reference signal (RS) overhead reduction.

In a second aspect, there is provided a method for communications implemented at a network device. The method comprises determining, at the network device, first information about a first Artificial Intelligence (AI) model associated with a first use case. The first use case comprises at least one of the following: mobility management for a terminal device, uplink resource allocation for the terminal device, channel state information (CSI) feedback enhancement, beam management, positioning accuracy enhancement, or reference signal (RS) overhead reduction. The method also comprises transmitting the first information about the first AI model to the terminal device.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a network device. The network device comprises a processor and a memory storing instructions. The memory and the instructions are configured, with the processor, to cause the network device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of an AI model in accordance with some embodiments of the present disclosure;

FIG. 3 illustrates an example signaling chart showing an example process for using an AI model at a terminal device in accordance with some embodiments of the present disclosure;

FIG. 4 illustrates a flowchart of an example method in accordance with some embodiments of the present disclosure;

FIG. 5 illustrates a flowchart of an example method in accordance with some other embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

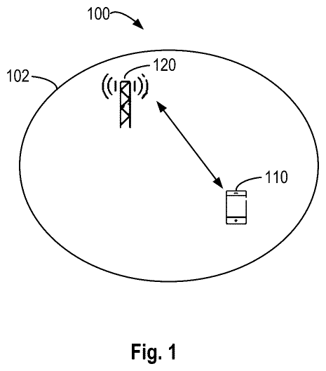

FIG. 1 shows an example communication network 100 in which embodiments of the present disclosure can be implemented. The network 100 includes a terminal device 110 and a network device 120 that serves the terminal device 110. A serving area of the network device 120 is called as a cell 102. It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the cell 102 and served by the network device 120.

Communications in the communication network 100 may be implemented according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

At least one of the terminal device 110 and the network device 120 may have AI or ML capability. Generally, an AI model which has been trained from numerous collected data for a specific function may be used to predict some information.

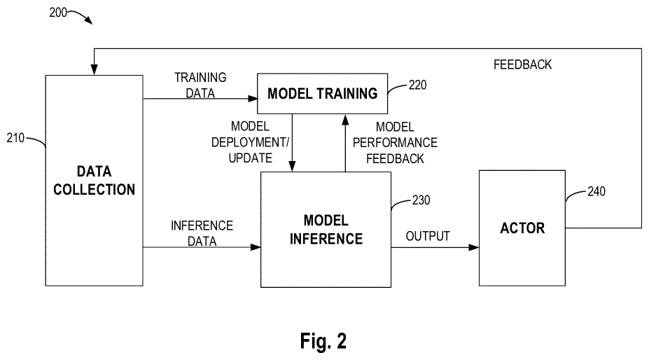

FIG. 2 illustrates an example of an AI model 200 in accordance with some embodiments of the present disclosure. As shown, the AI model 200 comprises a data collection function 210, a model training function 220, a model inference function 230, and an actor function 240.

The data collection function 210 may be a function that provides input data to the model training function 220 and the model inference function 230. Examples of input data may include measurements from terminal devices or different network entities, feedback from the actor function 240, output from the AI model 200.

The model training function 220 may be a function that performs training, validation, and testing of the AL model 200. The model training function 220 may be also responsible for data preparation (for example, data pre-processing and cleaning, formatting, and transformation) based on training data delivered by the data collection function 210, if required.

The model inference function 230 may be a function that provides an inference output (e.g. predictions or decisions) of the AI model 200. Hereinafter, the “inference output” will be also referred to as “output” for brevity. The model inference function 230 may be also responsible for data preparation (for example, data pre-processing and cleaning, formatting, and transformation) based on inference data delivered by the data collection function 210, if required.

The actor function 240 may be a function that receives the output from the model inference function 230 and triggers or performs corresponding actions. The actor function 240 may trigger actions directed to other entities or to itself.

The actor function 240 may also provide feedback to the data collection function 210. The feedback may include information that may be needed to derive training or inference data or performance feedback.

In the present disclosure, the model inference function 230 is performed by the terminal device 110. In some embodiments, the model training function 220 may be performed by the network device 120. In such embodiments, the network device 120 may configure the model inference function 230 to the terminal device 110. In some other embodiments, the model training function 220 may be performed by a further network device not shown in FIG. 1. For example, the model training function 220 may be performed by an Operations and Maintenance (OAM) device. In such embodiments, the further network device may configure the model inference function 230 to the terminal device 110.

In other embodiments, at least one AI model may be pre-configured at the terminal device 110. Each of the at least one AI model may be associated with at least one use case for the terminal device 110. The terminal device 110 may transmit information about the at least one AI model to the network device 120. For example, the information about the at least one AI model may indicate whether the terminal device 110 support the at least one AI model. For another example, the information about the at least one AI model may indicate the at least one Al model supported by the terminal device 110 and the at least one use case associated with each of the at least one AI model.

In some embodiments, in response to a use case being to be initiated, the network device 120 may transmit an enablement indication about the AI model to the terminal device 110.

Conventionally, mobility management for a terminal device is based on an AI model located at a network device, resulting in immediate information for mobility decision cannot be gathered. In addition, uplink resource allocation for the terminal device is based on token bucket mechanism. However, this mechanism only takes limited factors into consideration, which makes the output is not an optimal one.

Embodiments of the present disclosure provide a solution for using an AI model at a terminal device so as to solve the above problems and one or more of other potential problems. According to the solution, a terminal device receives, from a network device, first information about a first AI model and applies, based on the first information, the first AI model to a first use case associated with the first AI model. The first use case comprises at least one of the following: mobility management for the terminal device, uplink resource allocation for the terminal device, channel state information (CSI) feedback enhancement, beam management, positioning accuracy enhancement, reference signal (RS) overhead reduction. In this way, immediate information for mobility decision can be gathered. In addition, AI based uplink resource allocation may be achieved.

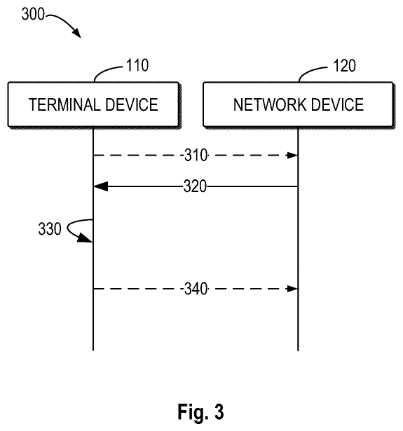

Principle of the present disclosure will now be described with reference to FIGS. 3 to 5. Reference is now made to FIG. 3, which shows a signaling chart illustrating a process 300 for using an AI model at a terminal device according to some example embodiments of the present disclosure. For the purpose of discussion, the process 300 will be described with reference to FIG. 1. The process 300 may involve the terminal device 110 and the network device 120 as illustrated in FIG. 1. Although the process 300 has been described in the communication network 100 of FIG. 1, this process may be likewise applied to other communication scenarios.

As shown in FIG. 3, the terminal device 110 receives (320) first information about a first AI model from the network device 120.

In turn, the terminal device 110 applies (330), based on the first information, the first AI model to a first use case associated with the first AI model. The first use case comprises at least one of the following: mobility management for the terminal device 110, uplink resource allocation for the terminal device 110, channel state information (CSI) feedback enhancement, beam management, positioning accuracy enhancement, or reference signal (RS) overhead reduction.

According to the present disclosure, because the first AI model is located at the terminal device 110, immediate information for mobility decision can be gathered. In addition, AI based uplink resource allocation may be achieved.

In some embodiments, at least one AI model may be pre-configured at the terminal device 110 and may comprise the first AI model. Each of the at least one AI model is associated with at least one use case for the terminal device 110. In such embodiments, the terminal device 110 may transmit (310) information about the at least one AI model to the network device 120. For example, the terminal device 110 may transmit the information about the at least one AI model with capability information about the terminal device 110.

In embodiments where the at least one AI model is pre-configured at the terminal device 110, the first information about the first AI model may comprise an enablement indication about the first AI model. In such embodiments, the terminal device 110 may receive the enablement indication about the first AI model in response to the first use case being to be initiated. For example, the terminal device 110 may receive the enablement indication via a radio resource control (RRC) message or system information.

In embodiments where the at least one AI model is not pre-configured at the terminal device 110, the network device 120 may configure the first AI model to the terminal device 110. In such embodiments, the first information about the first AI model may comprise configuration information about the first AI model. For example, the first information about the first AI model may comprise configuration information about a model inference function of the first AI model. In such embodiments, the network device 120 may configure the first AI model using an RRC message after security has been activated.

In embodiments where the network device 120 configures the first AI model, the first AI model may be delivered to the terminal device 110 as one container, the content of which is transparent to RRC layer. In embodiments where the network device 120 acts as a main node (MN), the MN may deliver the first AI model to the terminal device 110 by Signaling Radio Bearer (SRB), for example SRB 1 or SRB2. In embodiments where the network device 120 acts as a secondary node (SN), the SN may deliver the first AI model to the terminal device 110 by SRB, for example SRB 3. Alternatively, the SN may send the first AI model to MN, and MN delivers the first AI model to the terminal device 110 using SRB, for example SRB1 or SRB2. Alternatively, one or more new SRBs dedicated for AI model configuration may be used.

In some embodiments, the terminal device 110 may request the network device 120 to release one or more AI models by an RRC message if the terminal device 110 is overheating, or out of memory. The terminal device 110 may use an RRC message such as UEAssistanceInformation to request for the release of the one or more AI models, and the cause of the release such as overheating or out of memory may be included in the message.

In some embodiments, the terminal device 110 may apply the first AI model upon receiving the configuration information or the enablement indication of the first AI model.

In some embodiments, the terminal device 110 may apply an output of the first AI model directly. Alternatively, the terminal device 110 may report the output of the first AI model to a network device which configures the first AI model. It will be noted that the network device which configures the first AI model may be the identical to or difference from the network device 120. In this way, the network device may act according to the output from the terminal device 110, or use the output from the terminal device 110 as input of AI model (inference or training) at the network device.

In some embodiments, the terminal device 110 may report the output of the first AI model to the network device in a container, the content of which is transparent to RRC layer.

In some embodiments, the terminal device 110 may transmit (340) feedback information about the first AI model to the network device by a specified RRC IE or a dedicated message.

In some embodiments, if a model training function of the first AI model is located at the network side, such the network device 120 or OAM, the network may also configure or request the terminal device 110 to transmit feedback information about the first AI model to the network. In such embodiments, the network may use the feedback information as input of the model training function.

Currently, for a terminal device in a connected state, the mobility management (for example, handover, Primary Secondary Cell (PSCell) change) is up to network decision. In legacy, this is up to gNB implementation. Currently, in Release 17 RAN3 AI/ML study item, network based AI/ML for mobility performance optimization is being investigated. However, the network AI/ML model is based on feedback information from a terminal device, there may be delay and big amount of information can be reported to the network.

In order to solve above problem, in some embodiments, the terminal device 110 may apply the first AI model to the mobility management so as to obtain a first output of the first AI model. The first output is associated with the mobility management. In turn, the terminal device 110 may transmit the first output to the network device 120. The network device 120 may take the first output into account for final mobility configuration decision. For example, the terminal device 110 may transmit the first output by an RRC message such as UEAssistanceInformation. In this way, immediate information for mobility decision may be gathered and the immediate information is more accurate and efficient compared with legacy mobility procedure.

In some embodiments, the first output may comprise information about at least one of the following: at least one predicted candidate cell for handover or PSCell change, a predicted execution condition for each of the at least one predicted candidate cell, a predicted candidate frequency for the handover or the PSCell change, a predicted trajectory of the terminal device 110, a predicted moving velocity of the terminal device 110, or a predicted moving direction of the terminal device 110.

A Conditional Handover (CHO) is defined as a handover that is executed by a terminal device when one or more handover execution conditions are met. The terminal device starts evaluating the one or more execution conditions upon receiving the CHO configuration, and stops evaluating the one or more execution conditions once a handover (such as legacy handover or conditional handover execution) is executed. Similarly, Conditional PSCell addition/change (CPAC) is defined as a PSCell addition or change which is executed when at least one execution condition is met.

In some embodiments, the terminal device 110 may receive, from the network device 120, second information about CHO or CPAC. The second information indicates candidate cells for the CHO or the CPAC and indicates that an execution condition for the CHO or the CPAC is associated with a second output of the first AI model. In such embodiments, the terminal device 110 may perform the CHO or the CPAC in response to determining, based on the second output, that the execution condition is met,

In such embodiments, the second output may indicate at least one of the following: a first candidate cell among the candidate cells, or a probability that the terminal device 110 performs the CHO or the CPAC to the first candidate cell.

In such embodiments, the terminal device 110 may apply the first AI model in response to receiving the second information.

In such embodiments, in order to save power consumption, upon performing the CHO or the CPAC, the terminal device 110 may stop the first AI model.

Currently, the mobility management in an idle or inactive state of a terminal device is based on cell reselection. The cell reselection is based on many factors, for example, idle or inactive measurement, frequency priority, service, slicing. The current behavior of the terminal device may result in camping on a cell which not very suitable, and the network has to handover the terminal device to anther cell almost immediately after the terminal device accesses to the cell.

In order to solve above problem, in some embodiments, the first AI model may be an AI model for cell reselection or an AI model for idle/inactive state measurement relaxation. In such embodiments, the terminal device 110 may receive, from the network device 120, third information about a validity area for the first AI model. In turn, the terminal device 110 may apply, within the validity area, the first AI model to the mobility management in an idle or inactive state.

In some embodiments, if the terminal device 110 reselects to a cell which does not belongs to the validity area, the terminal device 110 may not apply the first model, suspend the first model, or release the first model.

In some embodiments, the validity area comprises at least one of the following: cells, a radio access network notification (RNA) area, or a tracking area.

In such embodiments, the terminal device 110 may transmit feedback information about the first AI model to the network device 120 in response to receiving a request for the feedback information from the network device 120. Alternatively, the terminal device 110 may transmit the feedback information about the first AI model based on a pre-configuration for the feedback information.

In such embodiments, the feedback information may comprise at least one of the following: mobility history information about the terminal device 110 when the first AI model is enabled, information about power used for measurement in the idle or inactive state, information related to an RRC setup failure or an RRC resume failure to a cell when the first AI model is enabled, or information related to a case where handover is performed soon after the terminal device 110 completes an RRC setup procedure or an RRC resume procedure to a cell when the first AI model is enabled.

For example, the mobility history information about the terminal device 110 may comprise information about trajectory and camped cell of the terminal device 110. The information about power used for measurement in the idle or inactive state may comprise level of power usage of the terminal device 110. The information related to an RRC setup failure or an RRC resume failure to a cell may indicate adding AI information in connection establishment failure report (also referred to as ConnEstFailReport).

In some embodiments, the terminal device 110 may receive, from the network device 120, fourth information about a validity timer for the first AI model. In turn, the terminal device 110 may apply the first AI model before an expiration of the validity timer. In such embodiments, the validity timer starts upon reception of configuration of the first AI model or reception of enablement of the first AI model. If the validity timer expiry, the terminal device 110 does not apply, suspend or release the first AI Model.

Currently, uplink resource allocation is based on token bucket mechanism. However, this mechanism only takes limited factors into consideration, which makes the output is not an optimal one.

In order to solve above problem, in some embodiments, the terminal device 110 may receive, from the network device 120, Quality of Service (QOS) parameters for radio bearers or logical channels. In turn, the terminal device 110 may apply the QoS parameters as an input of the first AI model to determine the uplink resource allocation. In this way, AI based uplink resource allocation may be achieved.

In some embodiments, the QoS parameters may comprise at least one of the following for the radio bearers or logical channels: packet delay budgets, maximum packet error rate or loss rate, guaranteed bit rates, maximum bit rates, prioritized bit rates, priority levels, survival time, or the fifth generation QoS identifier values (5Q1).

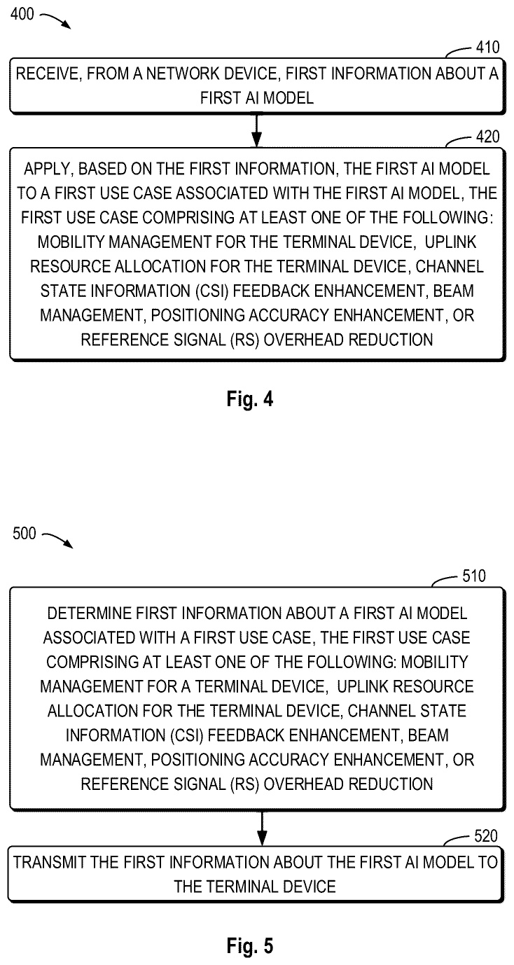

FIG. 4 illustrates a flowchart of an example method 400 in accordance with some embodiments of the present disclosure. In some embodiments, the method 400 can be implemented at a terminal device. For example, the method 400 can be implemented at the terminal device 110 as shown in FIG. 1.

At block 410, the terminal device 110 receives, from a network device, first information about a first AI model.

At block 420, the terminal device 110 applies, based on the first information, the first AI model to a first use case associated with the first AI model. The first use case comprises at least one of the following: mobility management for the terminal device, uplink resource allocation for the terminal device, channel state information (CSI) feedback enhancement, beam management, positioning accuracy enhancement, or reference signal (RS) overhead reduction.

In some embodiments, at least one AI model may be pre-configured and comprises the first AI model, each of the at least one AI model may be associated with at least one use case for the terminal device. The terminal device 110 transmits information about the at least one AI model to the network device.

In some embodiments, the terminal device 110 may transmit the information about the at least one AI model with capability information about the terminal device 110.

In some embodiments, in response to the first use case being to be initiated, the terminal device 110 may receive an enablement indication about the first AI model.

In some embodiments, the terminal device 110 may receive the enablement indication about the first AI model via a radio resource control message or system information.

In some embodiments, the terminal device 110 may apply the first AI model to the mobility management so as to obtain a first output of the first AI model, the first output being associated with the mobility management. In turn, the terminal device 110 may transmit the first output to the network device.

In some embodiments, the first output comprises information about at least one of the following: at least one predicted candidate cell for handover or Primary Secondary Cell (PSCell) change, a predicted execution condition for each of the at least one predicted candidate cell, a predicted candidate frequency for the handover or the PSCell change, a predicted trajectory of the terminal device, a predicted moving velocity of the terminal device, or a predicted moving direction of the terminal device.

In some embodiments, the terminal device 110 may receive, from the network device, second information about Conditional Handover (CHO) or Conditional Primary Secondary Cell (PSCell) addition or change (CPAC). The second information indicates candidate cells for the CHO or the CPAC and indicates that an execution condition for the CHO or the CPAC is associated with a second output of the first AI model. In such embodiments, the terminal device 110 may perform the CHO or the CPAC in response to determining, based on the second output, that the execution condition is met.

In some embodiments, the second output indicates at least one of the following: a first candidate cell among the candidate cells, or a probability that the terminal device performs the CHO or the CPAC to the first candidate cell.

In some embodiments, the terminal device 110 may apply the first AI model in response to receiving the second information.

In some embodiments, the terminal device 110 may receive, from the network device, third information about a validity area for the first AI model, and the terminal device 110 may apply, within the validity area, the first AI model to the mobility management in an idle or inactive state.

In some embodiments, the validity area comprises at least one of the following: cells, a radio access network notification area, or a tracking area.

In some embodiments, the terminal device 110 may transmit feedback information about the first AI model to the network device in response to receiving a request for the feedback information from the network device. Alternatively, the terminal device 110 may transmit the feedback information based on a pre-configuration for the feedback information.

In some embodiments, the feedback information comprises at least one of the following: mobility history information about the terminal device when the first AI model is enabled, information about power used for measurement in the idle or inactive state, information related to a Radio Resource Control (RRC) setup failure or an RRC resume failure to a cell when the first AI model is enabled, or information related to a case where handover is performed soon after the terminal device completes an RRC setup procedure or an RRC resume procedure to a cell when the first AI model is enabled.

In some embodiments, the terminal device 110 may receive, from the network device, fourth information about a validity timer for the first AI model, and the terminal device 110 may apply the first AI model before an expiration of the validity timer.

In some embodiments, the terminal device 110 may receive, from the network device, Quality of Service (QOS) parameters for radio bearers or logical channels, and the terminal device 110 may apply the QoS parameters as an input of the first AI model to determine the uplink resource allocation.

In some embodiments, the QoS parameters comprises at least one of the following for the radio bearers or logical channels: packet delay budgets, maximum packet error rate or loss rate, guaranteed bit rates, maximum bit rates, prioritized bit rates, priority levels, survival time, or the fifth generation QoS identifier values.

FIG. 5 illustrates a flowchart of an example method 500 in accordance with some embodiments of the present disclosure. In some embodiments, the method 500 can be implemented at a network device. For example, the method 500 can be implemented at the network device 120 as shown in FIG. 1.

At block 510, the network device 120 determines first information about a first AI model associated with a first use case. The first use case comprises at least one of the following: mobility management for a terminal device, uplink resource allocation for the terminal device, channel state information (CSI) feedback enhancement, beam management, positioning accuracy enhancement, or reference signal (RS) overhead reduction.

At block 520, the network device 120 transmits the first information about the first AI model to the terminal device.

In some embodiments, at least one AI model is pre-configured and comprises the first AI model. Each of the at least one AI model is associated with at least one use case for the terminal device. In such embodiments, the network device 120 may receive information about the at least one AI model from the terminal device.

In some embodiments, the network device 120 may receive the information about the at least one AI model with capability information about the terminal device.

In some embodiments, in response to the first use case being to be initiated, the network device 120 may transmit an enablement indication about the first AI model to the terminal device.

In some embodiments, the network device 120 may transmit the enablement indication about the first AI model via a radio resource control message or system information.

In some embodiments, the first AI model is applied to the mobility management so as to obtain a first output of the first AI model, the first output being associated with the mobility management. In such embodiments, the network device 120 may receive the first output from the terminal device.

In some embodiments, the first output comprises information about at least one of the following: at least one predicted candidate cell for handover or Primary Secondary Cell (PSCell) change, a predicted execution condition for each of the at least one predicted candidate cell, a predicted candidate frequency for the handover or the PSCell change, a predicted trajectory of the terminal device, a predicted moving velocity of the terminal device, or a predicted moving direction of the terminal device.

In some embodiments, the network device 120 may transmit, to the terminal device, second information about Conditional Handover (CHO) or Conditional Primary Secondary Cell (PSCell) addition or change (CPAC). The second information indicates candidate cells for the CHO or the CPAC and indicates that an execution condition for the CHO or the CPAC is associated with a second output of the first AI model.

In some embodiments, the second output indicates at least one of the following: a first candidate cell among the candidate cells, or a probability that the terminal device performs the CHO or the CPAC to the first candidate cell.

In some embodiments, the network device 120 may transmit, to the terminal device, third information about a validity area for the first AI model.

In some embodiments, the validity area comprises at least one of the following: cells, a radio access network notification area, or a tracking area.

In some embodiments, the network device 120 may transmit a request for the feedback information to the terminal device and the network device 120 may receive the feedback information based on the request.

In some embodiments, the network device 120 may receive the feedback information about the first AI model based on a pre-configuration for the feedback information.

In some embodiments, the feedback information comprises at least one of the following: mobility history information about the terminal device when the first AI model is enabled, information about power used for measurement in the idle or inactive state, information related to a Radio Resource Control (RRC) setup failure or an RRC resume failure to a cell when the first AI model is enabled, or information related to a case where handover is performed soon after the terminal device completes an RRC setup procedure or an RRC resume procedure to a cell when the first AI model is enabled.

In some embodiments, the network device 120 may transmit, to the terminal device, fourth information about a validity timer for the first AI model.

In some embodiments, the network device 120 may transmit, to the terminal device, Quality of Service (QOS) parameters for radio bearers or logical channels.

In some embodiments, the QoS parameters comprises at least one of the following for the radio bearers or logical channels: packet delay budgets, maximum packet error rate or loss rate, guaranteed bit rates, maximum bit rates, prioritized bit rates, priority levels, survival time, or the fifth generation QoS identifier values.

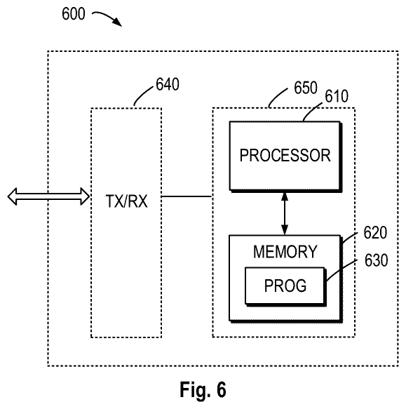

FIG. 6 is a simplified block diagram of a device 600 that is suitable for implementing some embodiments of the present disclosure. The device 600 can be considered as a further example embodiment of the terminal device 110 or the network device 120 as shown in FIG. 1. Accordingly, the device 600 can be implemented at or as at least a part of the terminal device 110 or the network device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 620 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communications, comprising:
receiving, at a terminal device from a network device, first information about a first Artificial Intelligence (AI) model; and
applying, based on the first information, the first AI model to a first use case associated with the first AI model, the first use case comprising at least one of the following:
mobility management for the terminal device,
uplink resource allocation for the terminal device,
channel state information (CSI) feedback enhancement,
beam management,
positioning accuracy enhancement, or
reference signal (RS) overhead reduction.

2. The method of claim 1, further comprising:
transmitting information about at least one AI model to the network device,
wherein the at least one AI model is pre-configured and comprises the first AI model, each of the at least one AI model is associated with at least one use case for the terminal device.

3. The method of claim 2, wherein transmitting the information about the at least one AI model comprises:
transmitting the information about the at least one AI model with capability information about the terminal device.

4. The method of claim 1, wherein receiving the first information about the first AI model comprises:
in response to the first use case being to be initiated, receiving an enablement indication about the first AI model.

5. The method of claim 4, wherein receiving the enablement indication about the first AI model comprises:
receiving the enablement indication about the first AI model via a radio resource control message or system information.

6. The method of claim 1, wherein applying the first AI model comprises:
applying the first AI model to the mobility management so as to obtain a first output of the first AI model, the first output being associated with the mobility management; and
the method further comprises:
transmitting the first output to the network device.

7. The method of claim 6, wherein the first output comprises information about at least one of the following:
at least one predicted candidate cell for handover or Primary Secondary Cell (PSCell) change,
a predicted execution condition for each of the at least one predicted candidate cell,
a predicted candidate frequency for the handover or the PSCell change,
a predicted trajectory of the terminal device,
a predicted moving velocity of the terminal device, or
a predicted moving direction of the terminal device.

8. The method of claim 1, further comprising:
receiving, from the network device, second information about Conditional Handover (CHO) or Conditional Primary Secondary Cell (PSCell) addition or change (CPAC), the second information indicating candidate cells for the CHO or the CPAC and indicating that an execution condition for the CHO or the CPAC is associated with a second output of the first AI model; and
wherein applying the first AI model comprises:
in response to determining, based on the second output, that the execution condition is met, performing the CHO or the CPAC.

9. The method of claim 8, wherein the second output indicates at least one of the following:
a first candidate cell among the candidate cells, or
a probability that the terminal device performs the CHO or the CPAC to the first candidate cell.

10. The method of claim 8, wherein applying the first AI model comprises:
in response to receiving the second information, applying the first AI model.

11. The method of claim 1, further comprising:
receiving, from the network device, third information about a validity area for the first AI model; and
applying the first AI model comprises:
applying, within the validity area, the first AI model to the mobility management in an idle or inactive state.

12. The method of claim 11, wherein the validity area comprises at least one of the following:
cells,
a radio access network notification area, or
a tracking area.

13. The method of claim 11, further comprising:
transmitting feedback information about the first AI model to the network device, comprising:
in response to receiving a request for the feedback information from the network device, transmitting the feedback information; or
transmitting the feedback information based on a pre-configuration for the feedback information.

14. The method of claim 13, wherein the feedback information comprises at least one of the following:
mobility history information about the terminal device when the first AI model is enabled,
information about power used for measurement in the idle or inactive state,
information related to a Radio Resource Control (RRC) setup failure or an RRC resume failure to a cell when the first AI model is enabled, or
information related to a case where handover is performed soon after the terminal device completes an RRC setup procedure or an RRC resume procedure to a cell when the first AI model is enabled.

15. The method of claim 1, further comprising:
receiving, from the network device, fourth information about a validity timer for the first AI model; and
applying the first AI model comprises:
applying the first AI model before an expiration of the validity timer.

16. The method of claim 1, further comprising:
receiving, from the network device, Quality of Service (QOS) parameters for radio bearers or logical channels;
applying the first AI model comprises:
applying the QoS parameters as an input of the first AI model to determine the uplink resource allocation.

17. The method of claim 16, wherein the QoS parameters comprises at least one of the following for the radio bearers or logical channels:
packet delay budgets,
maximum packet error rate or loss rate,
guaranteed bit rates,
maximum bit rates,
prioritized bit rates,
priority levels,
survival time, or
the fifth generation QoS identifier values.

18. A method for communications, comprising:
determining, at a network device, first information about a first Artificial Intelligence (AI) model associated with a first use case, the first use case comprising at least one of the following:
mobility management for a terminal device,
uplink resource allocation for the terminal device,
channel state information (CSI) feedback enhancement,
beam management,
positioning accuracy enhancement, or
reference signal (RS) overhead reduction; and
transmitting the first information about the first AI model to the terminal device.

19. The method of claim 18, further comprising:
receiving information about at least one AI model from the terminal device; and
wherein the at least one AI model is pre-configured and comprises the first AI model, each of the at least one AI model is associated with at least one use case for the terminal device.

20. The method of claim 19, wherein receiving the information about the at least one AI model comprises:
receiving the information about the at least one AI model with capability information about the terminal device.

21-37. (canceled)
